(19) United States
(12) Patent Application Publication
(10) Pub. No.: US 2009/0102262 A1
(43) Pub. Date: Apr. 23, 2009

(54) Device for the transmission of a rotation motion with a flexible shaft in a sheath comprising shoulder-forming areas and an inner tube

(75) Inventor: Denis Tores, Vaux Le Penil (FR)

Correspondence Address: HARNESS, DICKEY & PIERCE, P.L.C., P.O. BOX 828, BLOOMFIELD HILLS, MI, 48303, US

(73) Assignee: Inderflex Technoflex, Le Chateler en Brie (FR)

(21) Appl. No.: 11/989,161

(22) PCT Filed: Jul. 21, 2006
(86) PCT No.: PCT/FR2006/001791

§ 371 Date: Jun. 3, 2008

(30) Foreign Application Priority Data
Jul. 22, 2005 (FR) 0552269

(51) Int. Cl. F16C 1/06; B60N 2/06; F16C 1/26

(52) U.S. Cl. 297/344.1; 464/56

(57) ABSTRACT

A device for the transmission of a rotation motion (1) comprising a flexible shaft and a sheath (3), said sheath (3) comprising a core (4), the core (4) comprising at least one shoulder-forming area (6), said area (6) comprising at least three portions, two external portions (7, 8) and a central portion (9), said portions having axes substantially parallel to that of the core (4) and having diameters substantially equal to that of the core (4), the external portions (7, 8) being substantially coaxial and having their axes shifted with respect to the axis of the central portion (9) and of the core (4), said device comprises an inner tube (2) positioned inside the core (4) the tube (2) being deformed in a similar way as the core (4) in the shoulder-forming area (6).

This invention is related to a device for the transmission of a rotation motion and an adjustment system for the seat of a motor vehicle comprising such a device.

Rotation transmission devices are known which comprise a flexible shaft and a sheath inside which the shaft is accommodated.

In such transmission devices, the rotation speeds of the shaft in the sheath are above 2,000 rotations per minute, traditionally of the order of 3,000 rotations per minute.

To allow a rotation at such speeds, a clearance of a few tens of millimetres is required between the sheath and the shaft, but such clearance, during the rotation, entails the occurrence of low magnitude vibrations which propagate along the shaft and cause unpleasant noise and feeling.

To solve such vibration issue, document FR-1 563 195 provides a rotation transmission device, the sheath of which has at least one deformation in the form of a shoulder-forming area which is obtained through the plastic deformation of the core of the sheath, such area comprises at least three portions, two external portions and one central portion. Such portions have axes which are substantially parallel that of the core, and have diameters which are substantially equal to that of the core, the external portions being substantially coaxial and having an axis shifted with respect to the axes of the central portion and of the core. As a matter of fact, such shoulder-forming area makes it possible to limit the vibrations by creating contact points between the shaft and the sheath.

In order to reduce the frictions, such document provides the making of a fibre flocking on the inner surface of the sheath core. However, flocking wears with an intensive use of the rotation transmission device. As a matter of fact, the shaft is made by a winding of metal wires and has an outer surface which is not smooth. The flocking fibres are likely to get caught in the irregularities of the outer surface of the shaft and to be stripped upon the rotation of the shaft.

The aim of this invention is to remedy such disadvantages by providing a device for the transmission of a rotation motion, the sheath of which has permanent deformations which are arranged so as to limit the vibrations without reducing the internal diameter of the sheath and comprising an inner tube having the same deformations.

For this purpose and according to a first aspect, the invention relates to a device for the transmission of a rotation motion comprising a flexible shaft and a sheath, inside which the shaft is accommodated, such sheath comprising a core constituted of a hollow cylinder, the internal diameter of which is so arranged as to allow the rotation of said shaft inside said core, the core comprising at least one shoulder-forming area which is obtained by plastic deformation, said area comprising at least three portions, two external portions and one central portion, said portions having axes which are substantially parallel to that of the core and having diameters which are substantially equal to that of the core, the external portions being substantially coaxial and having an axis shifted with respect to the axes of the central portion and of the core, said device further comprising an inner tube positioned inside the core and the outer diameter of which is substantially equal to the internal diameter of the core and the internal diameter of which is so arranged as to allow the rotation of said shaft inside said tube, the tube being deformed in a similar way as the core in the shoulder-forming area.

The inner surface of the tube is smooth and thus makes it possible to limit the frictions between the shaft and the sheath. The tube is made of a plastic material which avoids contacts between metals, thus reducing the noise and the wear of materials.

According to one embodiment, the central portion of the shoulder-forming area and the core on the sheath are substantially coaxial.

According to another embodiment, the sheath comprises several shoulder-forming areas spaced from each other by a distance between 5 and 15 centimetres.

According to another embodiment, the areas are positioned continuously along the sheath.

According to one embodiment, the non-deformed inner tube is introduced into the non-deformed core, then the deformations creating the shoulder-forming areas are carried out simultaneously on the core and on the inner tube.

According to a second aspect, the invention is relates to a system for adjusting the seat of a motor vehicle, comprising at least one adjustment slide mounted on the vehicle structure and adjustable means for fixing the sheath on the slide, the system further comprising a driving motor having at least one rotating output. The system further comprises a device for the transmission of a rotation motion of the type described hereabove, which is positioned between the output of said driving motor and said fixing means, so as to make the fixing means move along the adjustment slide, in response to a rotation of the output.

The invention is not limited to such an application. As a matter of fact, the device can be used in any application, the system of which must remotely transmit a torque or a rotation, with some comfort as regards the noise and the attenuation of the vibrations. Such a device can for example be used for adjusting the height of a desk or the opening control for the roof of a motor vehicle.

The invention will be better understood when reading the following description, and referring to the appended Figures.

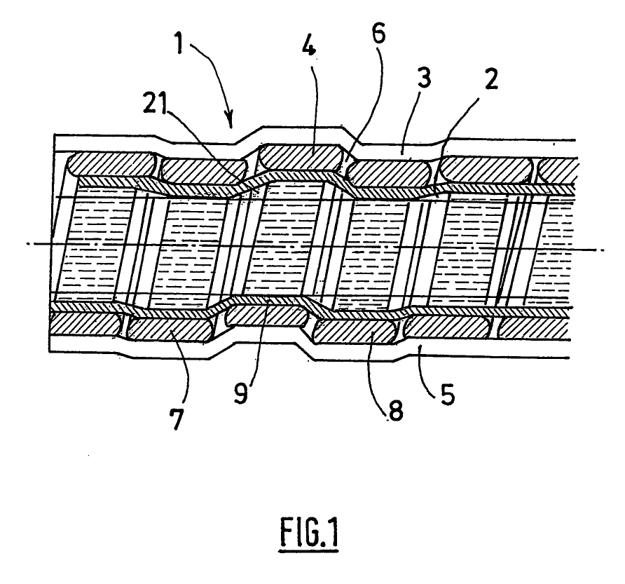

FIG. 1 is a partial view in longitudinal cross-section of a device for the transmission of rotation, showing a shoulder-forming area according to one embodiment of the invention.

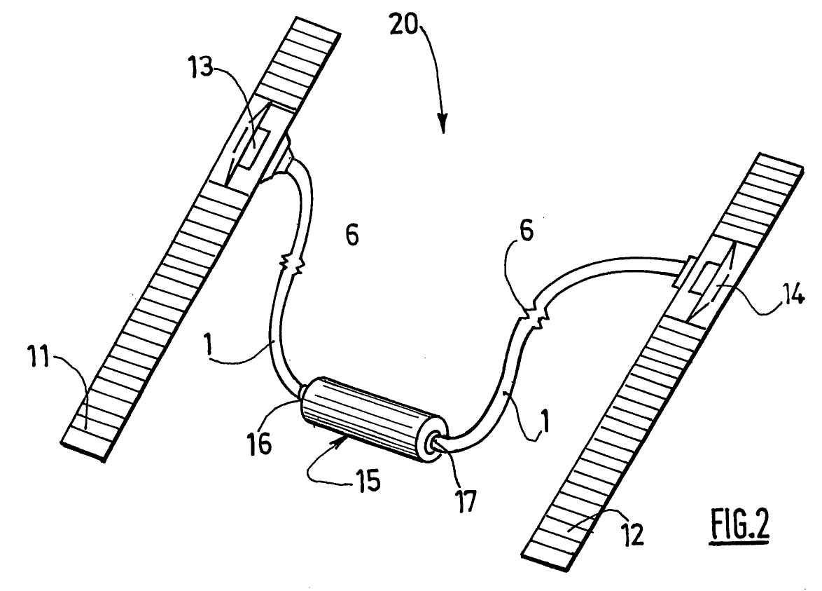

FIG. 2 is a perspective view of a system for adjusting the seat of a motor vehicle according to the invention.

A device for the transmission of a rotation motion 1 comprises a flexible shaft (not shown) and a sheath 3. The shaft is accommodated in the sheath 3.

The shaft rotation speeds are traditionally of about 3,000 rotations per minute. To allow a rotation at such speed, a clearance of a few tens of millimetres is provided between the shaft and the sheath 3.

The sheath 3 comprises a core 4 and an external tubular enclosure 5 which encloses the core 4. The core 4 may, for example, be constituted of a coil spring made of a metallic material. Such spring is, for example, constituted of an helically coiled metallic strip. The wounds of the spring are not jointed, which gives the sheath some flexibility. The external enclosure 5 can be made of an extruded plastic material.

Referring to FIG. 1, the sheath 3 has a permanent deformation in the form of a shoulder-forming area 6, the shoulder extending in the longitudinal direction of the device.

A shoulder-forming area comprises three portions, 2 external portions 7 and 8, and a central portion 9. The axis of each of these portions is substantially parallel to that of the core 4. The external portions 7 and 8 are further coaxial and their axes are shifted with respect to that of the core 4. In the description, the axes are defined in a stable rectilinear position of the sheath, as shown in FIG. 1.

Besides, each portion 7-9 has an internal diameter which is substantially equal to the internal diameter of the core 4 and comprises an integer number of consecutive turns.

According to the embodiment of the invention shown in the FIG. 1, the shoulder-forming area 6 of the transmission device 1 comprises two external portions 7, 8, and a central portion 9 constituted by only one turn. The axis of each portion is shifted with respect to the axis of the core 4, so that the common axis of the external portions 7, 8 and the axis of the central portion 9 are substantially symmetric with respect to the axis of the core 4.

According to another embodiment of the invention, the shoulder-forming area 6 of the transmission device 1 comprises two external portions 7, 8 constituted of only one turn and a central portion 9 constituted of two turns. The central portion 9 is further coaxial with the core 4 of the sheath.

According to the invention, several shoulder-forming areas can be distributed along the sheath. In one embodiment, the distance separating two areas is traditionally between 5 millimetres and 15 centimetres. According to another embodiment, the areas are positioned continuously along the sheath.

The shoulder-forming area 6 entails that the axis of the metal turns of the sheath 3 are shifted, without any reduction in the internal diameter of said turns. This creates a slightly meandering path inside the sheath 3.

The deformations of the sheath 3 are made by a plastic deformation of the sheath, for instance using a press the jaws of which are arranged to radially shift the turns. Such deformations are permanent and the mounting of the device requires no additional holding part for these deformations.

Referring to FIG. 1, the sheath 3 comprises an inner tube 2 on its inner surface, i.e. the surface opposite the shaft. The inner tube 2 is positioned inside the core 4 and its external diameter is substantially equal to the internal diameter of the core 4. This means that the inner tube 2 is positioned against the inner surface of the core 4. The internal diameter of the tube is so arranged as to allow the rotation of the shaft inside the tube 2.

The tube 2 is deformed in the same way as the core in the shoulder-forming area or areas 6, which means that the tube 2 also has shoulder-forming areas at the same places as the shoulder-forming areas 6, as shown in FIG. 1. Thus, contact points are created between the tube 2 and the shaft, which are opposite with respect to the axis of the sheath 3 and staggered on either side of such axis. Such contact points avoid any possibility for the shaft to vibrate during its motion, without reducing its speed in any way. The torque of the motor can then be analogous to the one used with non-deformed sheaths and the sheath has no tendency to a precocious wear, as far as the formations are concerned. Besides, the free spaces between the tube 2 and the flexible shaft can store grease 21 for lubricating the shaft.

For example, the tube 2 is made of a plastic material which avoids metal/metal contacts. The non-deformed tube 2 is introduced into the non-deformed sheaths 3, then, the deformation operation on the sheath 3 entails an analogous deformation of the tube 2. The manufacturing of the sheath 3 is thus particularly simple.

As a matter of fact, it should be noted that such an arrangement, in which the sheath comprises a tube made of plastic on its inner surface had a maximum sound damping effect. The tube 2 provides a mechanical isolation between the shaft and the sheath.

Such a device for the transmission of a rotation motion can be used in a system for adjusting s seat in a motor vehicle 20 such as shown in FIG. 2.

For this purpose, two slides 11 and 12 are fixed on the (not shown) structure of a motor vehicle, by any appropriate means. Such slides have adjustment notches, the function of which will be described hereunder.

The slides 11 and 12 support the frame of a seat, also not shown, of the vehicle, the displacement and fixing of which with respect to the slides are secured by reducers 13 and 14, respectively provided with two sprocket wheels cooperating with the above-mentioned notches of the slides 11 and 12.

An electric motor 15 is fixed to the vehicle structure or, as an alternative, to the frame of the seat of the seat. Such motor 15 has two rotating outputs 16 and 17. Such outputs 16 and 17 are connected by devices for the transmission of a rotation motion 1 according to the invention to the reducers 13 and 14, respectively.

The shoulder-forming area 6 of the transmission devices 1 are provided at locations on the sheath which are substantially rectilinear, during the mounting in the adjustment system 20. As a matter of fact, it has been observed that abrasions occur and propagate in the most important way, at such locations.

When the motor 15 is on, it drives the shafts of the transmission devices 1 into rotation inside their sheaths. Such shafts in turn drive the reducers 13 and 14, which results in the displacement of the sheath along the slides 11 and 12.

As mentioned above, the device 1 also has applications in other fields and can be used so long as a system must remotely transmit a torque or a rotation, with some comfort as regards the noise and the attenuation of the vibrations.

1. A device for the transmission of a rotation motion comprising a flexible shaft and a sheath inside which the shaft is accommodated, said sheath comprising a core constituted of a cylinder, the core comprising at least one shoulder-forming area which is obtained by a plastic deformation, said area comprising at least three portions, two external portions and a central portion, said portions having axes substantially parallel to that of the core and having diameters substantially equal to that of the core, the external portions being substantially coaxial and having their axes shifted with respect to the axis of the central portion and of the core, an inner tube positioned inside the core and the external diameter of which is substantially equal to the internal diameter of the core and the internal diameter of which is so arranged as to allow the rotation of said shaft inside said tube, the tube being deformed in a similar way as the core in the shoulder-forming area.

2. A transmission device according to claim 1, wherein the central portion of the shoulder-forming area and the core of the sheath are substantially coaxial.

3. A transmission device according to claim 1, wherein the core of the sheath is constituted of a coil spring made of a metallic material.

4. A transmission device according to claim 3, wherein each portion of the shoulder-forming area comprises an integer number of turns of the coil spring.

5. A transmission device according to claim 1, wherein turns of each portion of the shoulder-forming area are consecutive.

6. A transmission device according to claim 1, wherein the external portions of the shoulder-forming area comprise, each, one turn and in that the central portion comprises two turns.

7. A transmission device according to claim 1, wherein the sheath comprises several shoulder-forming areas, said areas being spaced from each other by a distance between 5 and 10 centimetres.

8. A transmission device according to claim 1, wherein the sheath comprises several shoulder-forming areas, said areas being positioned continuously along the sheath.

9. A transmission device according to claim 1, wherein the sheath further comprises an external tubular enclosure made of a plastic material which encloses the core.

10. A transmission device according to claim 1, further comprising an inner tube made of a plastic material and deformed simultaneously to the core to give the shoulder-forming area.

11. A system for adjusting a seat in a motor vehicle, the system comprising at least one adjustment slide mounted on vehicle structure and an adjuster operably fixing the seat on said slide, a driving motor having at least one rotating output, a transmission device positioned between the output of said driving motor and said adjuster, so as to make the adjuster move along said adjustment slide in response to a rotation of said output.

12. A system according to claim 11, wherein the adjuster comprises shoulder-forming areas provided at locations of a sheath which are substantially rectilinear.
